(19) United States
(12) Patent Application Publication
(10) Pub. No.: US 2022/0172478 A1
(43) Pub. Date: Jun. 2, 2022

(54) VIDEO SYNCHRONIZATION DEVICE, VIDEO SYNCHRONIZATION METHOD, AND PROGRAM

(71) Applicant: NIPPON TELEGRAPH AND TELEPHONE CORPORATION, Tokyo (JP)

(72) Inventors: Siqi SUN, Tokyo (JP); Kosuke TAKAHASHI, Tokyo (JP); Dan MIKAMI, Tokyo (JP); Mariko ISOGAWA, Tokyo (JP); Yoshinori KUSACHI, Tokyo (JP)

(73) Assignee: NIPPON TELEGRAPH AND TELEPHONE CORPORATION, Tokyo (JP)

(21) Appl. No.: 17/442,077

(22) PCT Filed: Mar. 11, 2020
(86) PCT No.: PCT/JP2020/010461

§ 371 Date: Sep. 22, 2021

(30) Foreign Application Priority Data
Mar. 25, 2019 (JP) 2019-056698

(51) Int. Cl. G06V 20/40; G06T 5/00; G06T 7/20; G06T 7/70; H04N 5/04

(52) U.S. Cl. CPC G06V 20/48; G06T 5/002; G06T 7/20; G06T 2207/30196; H04N 5/04; G06T 2207/10016; G06T 2207/20182; G06T 7/70

(57) ABSTRACT

A video image synchronization device capable of stably synchronizing multiple viewpoint video images is provided. The video image synchronization device includes: a norm calculation unit that, from chronological data of a coordinate of each of joints of a human body in each of video images taken from a plurality of viewpoints, calculates a norm that is a movement amount per unit time of the joint in the video image; a motion rhythm detection unit that based on the norms, detects a motion rhythm including a movement start timing and a movement stop timing, for each of the joints in each of the video images; and a time shift detection unit that based on the motion rhythms of the respective joints in the respective video images, calculates a matching score indicating a degree of stability of a time shift between the video images and detects a time shift whose matching score is high.

### TECHNICAL FIELD

The present invention relates to a video image synchronization device, a video image synchronization method and a program that synchronize multiple viewpoint video images.

### BACKGROUND ART

As a conventional technique relating to synchronization of non-synchronous multiple viewpoint video images, for example, there is Non-Patent Literature

In Non-Patent Literature 1, a time shift between cameras is calculated based on a geometric constraint (epipolar constraint) placed between multiple viewpoint video images. In Non-Patent Literature 1, it is necessary to obtain correspondence points between multiple viewpoint video images.

### CITATION LIST

### Non-Patent Literature

Non-Patent Literature 1: C. Albl, Z. Kukelova, A. Fitzgibbon, J. Helier, M. Smid and T. Pajdla, “On the Two-View Geometry of Unsynchronized Cameras,” 2017 IEEE Conference on. Computer Vision and Pattern Recognition (CVPR), Honolulu, Hi., 2017, pp. 5593-5602

### SUMMARY OF THE INVENTION

### Technical Problem

Where cameras are installed on a wide baseline (where a disparity between cameras is large), a difference occurs in vision of feature points that should correspond to each other between images, resulting in difficulty to stably acquire correspondence points between multiple viewpoint video images and thus resulting in failure of synchronization.

Also, where an initial time shift (time shift between video images at the time of being provided as an input) is large (no less than approximately two seconds), a result of estimation using an error function is prone to have a local minimum value, and thus, estimation of a time shift between cameras fails in many cases.

Also, where the correspondence points have detection errors, accuracy of synchronization significantly decreases.

Therefore, an object of the present invention is to provide a video image synchronization device capable of stably synchronizing multiple viewpoint video images.

### Means for Solving the Problem

A video image synchronization device of the present invention includes a norm calculation unit, a motion rhythm detection unit, and a time shift detection unit.

The norm calculation unit calculates, from chronological data of a coordinate of each of joints of a human body in each of video images taken from a plurality of viewpoints, a norm that is a movement amount per unit time of the joint in the video image. The motion rhythm detection unit detects, based on the norms, a motion rhythm including a movement start timing and a movement stop timing, for each of the joints in each of the video images. The time shift detection unit calculates, based on the motion rhythms of the respective joints in the respective video images, a matching score indicating a degree of stability of a time shift between the video images and detects a time shift whose matching score is high.

### Effects of the Invention

The video image synchronization device of the present invention enables stably synchronizing multiple viewpoint video images.

### BRIEF DESCRIPTION OF DRAWINGS

FIG. 1 is a block diagram illustrating a configuration of a video image synchronization device of Embodiment 1.

FIG. 2 is a flowchart illustrating operation of the video image synchronization device of Embodiment 1.

FIG. 3 is a block diagram illustrating a configuration of a norm calculation unit of Embodiment 1.

FIG. 4 is a flowchart illustrating operation of the norm calculation unit of Embodiment 1.

FIG. 5 is a block diagram illustrating a configuration of a motion rhythm detection unit of Embodiment 1.

FIG. 6 is a flowchart illustrating operation of the motion rhythm detection unit of Embodiment 1.

FIG. 7 is a block diagram illustrating a configuration of a time shift detection unit of Embodiment 1.

FIG. 8 is a flowchart illustrating operation of the time shift detection unit of Embodiment 1.

FIG. 9 is a diagram illustrating an example operation of a movement start timing detection unit of Embodiment 1.

FIG. 10 is a diagram illustrating an example operation of a movement stop timing detection unit of Embodiment 1.

FIG. 11 is a diagram illustrating example operation 1 of the time shift detection unit of Embodiment 1.

FIG. 12 is a diagram illustrating example operation 2 of the time shift detection unit of Embodiment 1.

### DESCRIPTION OF EMBODIMENTS

An embodiment of the present invention will be described in detail below. Note that component units having a same function are provided with a same reference numeral and overlapped description thereof is omitted.

### Embodiment 1

### Overview

An overview of processing in a video image synchronization device 1 of Embodiment 1 will be described below. The video image synchronization device 1 of Embodiment 1 detects feature points in video images and uses the feature points for synchronization of the video images. The video image synchronization device 1 of the present embodiment uses two-dimensional joint coordinates of a person detected using a conventional technique, as feature points. An example of the conventional technique can be OpenPose (Reference Non-Patent Literature 1).

(Reference Non-Patent Literature 1: Cao, Zhe, et al. “Realtime multi-person 2d pose estimation using part affinity fields.” 2017 IEEE Conference on Computer Vision and Pattern Recognition (CVPR). IEEE, 2017.)

By setting these two-dimensional joint coordinates as feature points and providing the feature points with joint labels, even if there are large differences in vision of the feature points due to wide-baseline camera installation, correspondences can stably be obtained, and thus, stable time shift estimation is enabled.

The video image synchronization device 1 of the present embodiment, which pays attention to the fact that in respective video images taken of a same person from multiple viewpoints, each of a start and an end of movement of each joint takes place at a same timing, detects a timing sequence (hereinafter referred to as “motion rhythm”) from each video image and matches the timing sequences to synchronize the video images. The epipolar geometry-based method of the conventional technique uses a geometric constraint strictly placed between correspondence points and thus is sensitive to noise, and in a case where there is a large initial time shift and the correspondence points have large detection errors, often fails to estimate a time shift. On the other hand, the video image synchronization device 1 of the present embodiment enables stable synchronization even in the above case by use of motion rhythm, which is a characteristic that is not sensitive to noise.

### Video Image Synchronization Device 1

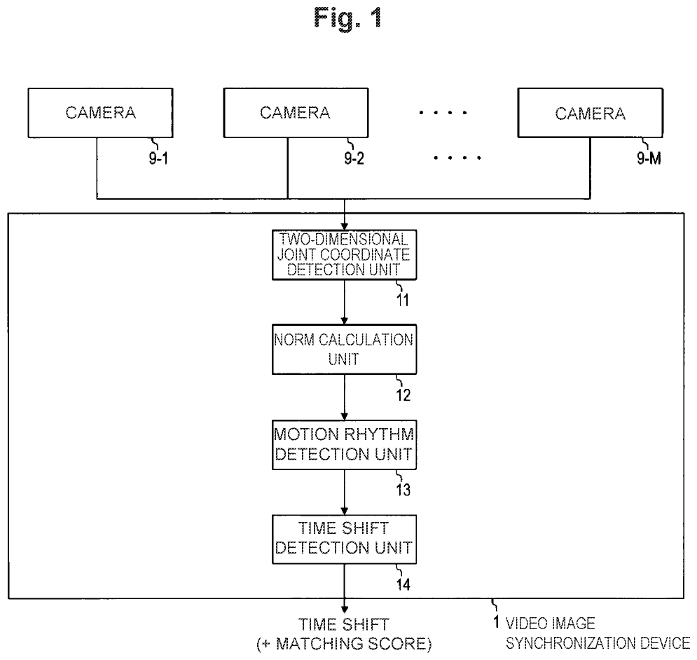

A configuration of the video image synchronization device 1 of the present embodiment will be described below with reference to FIG. 1. As illustrated in the figure, the video image synchronization device 1 of the present embodiment includes a two-dimensional joint coordinate detection unit 11, a norm calculation unit 12, a motion rhythm detection unit 13 and a time shift detection unit 14. The video image synchronization device 1 of the present embodiment acquires, from cameras 9-1, . . . , 9-M (M is an integer of no less than 2) capable of taking video images from viewpoints that are different from one another video images from M viewpoints. Also, the two-dimensional joint coordinate detection unit 11 does not necessarily need to be a component inside the video image synchronization device 1 but may be a component of another device.

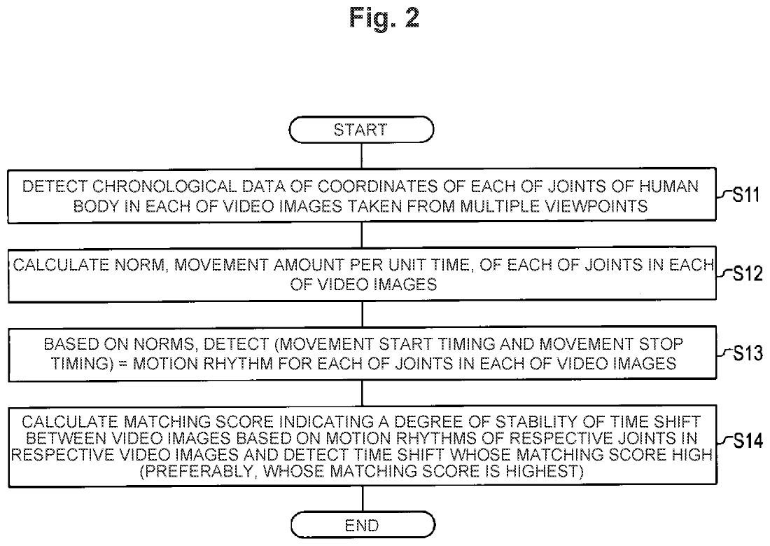

Operation of the video image synchronization device 1 of the present embodiment will be described below with reference to FIG. 2. The two-dimensional joint coordinate detection unit 11 acquires video images taken of at least one person from a plurality of viewpoints M viewpoints. In the present embodiment, for sake of simplicity, M=2, the video image synchronization device of the present invention is not limited to this example), and detects chronological data of two-dimensional coordinates of each of joints of a human body in each of the video images (S11). For each of the joints, the detected chronological data of the two-dimensional coordinates is provided with a joint label (joint number). For the acquisition of the two-dimensional coordinates of the joints, a conventional technique can be used. For example, the method of Reference Non-Patent Literature 1 can be used.

The norm calculation unit 12 calculates a norm that is a movement amount per unit time of each of the joints of the human body in each of the video images taken from the plurality of viewpoints (in the present embodiment, two viewpoints), from the chronological data of the coordinates of the joint in the video image (S12). At this time, the norm calculation unit 12 preferably filters two-dimensional coordinates x, y of the acquired joints using smoothing filters (for example, a median filter and a Savitzky-Golay filter) (which will be described later).

Based on the norms, the motion rhythm detection unit 13 detects a motion rhythm including movement start timings and movement stop timings for each of the joints in each of the video images according to predetermined detection rules (which will be described later) (S13).

The time shift detection unit 14 calculates matching scores each indicating a degree of stability of a time shift between the video images based on the motion rhythms of the respective joints in the respective video images and detects a time shift whose matching score is high (preferably a time shift whose matching score is highest) (S14).

### Detailed Operation

Operations of respective elements of the video image synchronization device 1 of the present embodiment will be described in further detail below.

### Two-Dimensional Joint Coordinate Detection Unit 11

The two-dimensional joint coordinate detection unit 11 receives an input of video images taken from multiple viewpoints (in the present embodiment, two viewpoints) (video images taken of a least one person from different viewpoints), obtains two-dimensional joint coordinates of the person in each frame, and outputs x and v coordinates of each of joints in each of the video images (more specifically, sets of a video image number, a frame number, joint numbers x and y coordinates of joints) to the norm calculation unit 12 (S11).

As described above, a method of estimation of two-dimensional joint coordinates of a person may be any method, and for example, the method disclosed in Reference Non-Patent Literature 1 may be used. It is necessary that at least one common joint be included in all the video images. Note that as the number of joints that can be detected is larger, synchronization accuracy increases, but calculation costs also increases. The number of joints that can be detected depends on the two-dimensional joint estimation method (for example, Reference Non-Patent Literature 1). Examples of data output from the two-dimensional joint coordinate detection unit 11 where 14 joint positions are used are indicated below.

(video image number: 1, frame number: 1, joint number: 1, coordinates: x: 1022, y: 878, . . . , joint number: 14, coordinates: X: 588, Y: 820)
(video image number: 2, frame number: 1, joint number: 1, coordinates: x: 1050, y: 700, . . . , joint number: 14, coordinates: X: 900, 1: 1020)

### Norm Calculation Unit 12

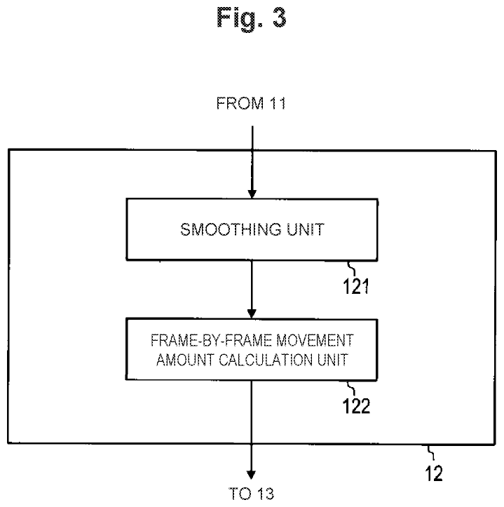

As illustrated in FIG. 3, the norm calculation unit 12 includes a smoothing unit 121 and a frame-by-frame movement amount calculation unit 122.

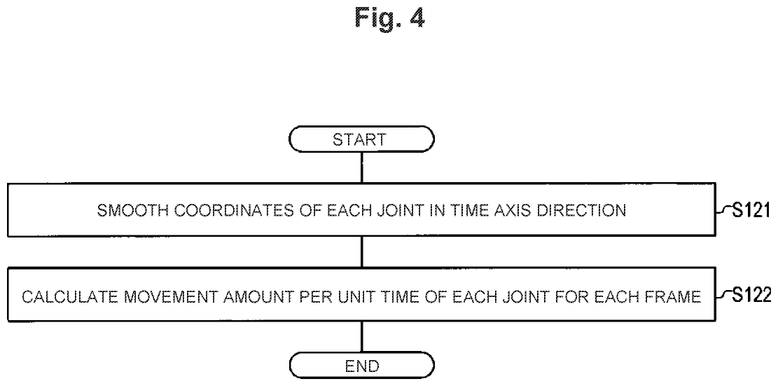

As illustrated in FIG. 4, the smoothing unit 121 receives an input of the x and y coordinates of the respective joints in the respective images and performs smoothing of the x and y coordinates of the respective joints in a time axis direction (S121). In the case of, for example, an input video image of 30 fps, the smoothing unit 121 needs to perform smoothing by shifting a smoothing window for a unit of 11 frames one frame by one frame. Note that a parameter relating to smoothing needs to be set in such a manner as to enable reduction of an error and clear recognition of change in coordinates of the joints in the time axis direction.

Next, for each frame, the frame-by-frame movement amount calculation unit 122 calculates a movement amount per unit time (for example, on a frame-by-frame basis) (norm) of each joint, using the smoothed x and y coordinates (S122). A L₂ norm n^{t}_{i, j} of a j-th joint at a time t from a viewpoint i is represented by Expression (1). Note that (x^{t}_{i, j}, y^{t}_{i, j}) is a two-dimensional coordinate value of the j-th joint of the human body in a t-th frame, the human body being included in a video image taken from the viewpoint i. The frame-by-frame movement amount calculation unit 122 calculates the norm at least using a difference for one frame. It is assumed that α is a temporal difference (frame count) in calculation of the norm. Any value can be set as α. For example, it is possible to perform synchronizations with various values taken as α in simulations and use a value of α that provides a highest synchronization accuracy.

$$\begin{matrix}[ Math . 1 ] & \\ {n}_{i , j}^{t} = \sqrt{\vert {x}_{i , j}^{t + α} - {x}_{i , j}^{t} \vert + \vert {y}_{i , j}^{t + α} - {y}_{i , j}^{t} \vert} & ( 1 )\end{matrix}$$

The frame-by-frame movement amount calculation unit 122 outputs chronological data of the norms of the respective joints in the respective video images, more specifically, (video image numbers, frame numbers, joint numbers, and norms of the respective joints), to the motion rhythm detection unit 13.

### Motion Rhythm Detection Unit 13

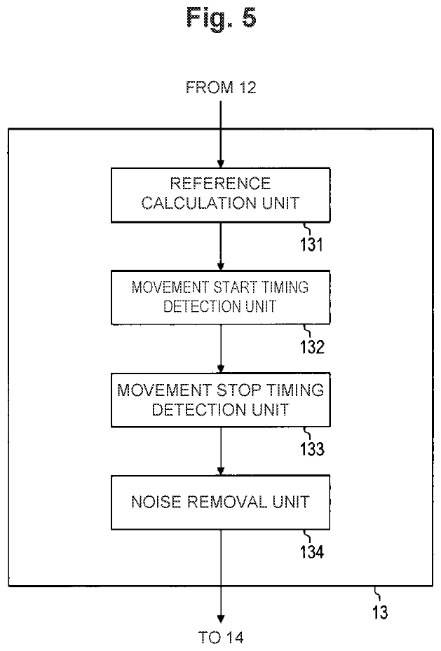

As illustrated in FIG. 5, the motion rhythm detection unit 13 includes a reference calculation unit 131, a movement start timing detection unit 132, a movement stop timing detection unit 133 and a noise removal unit 134.

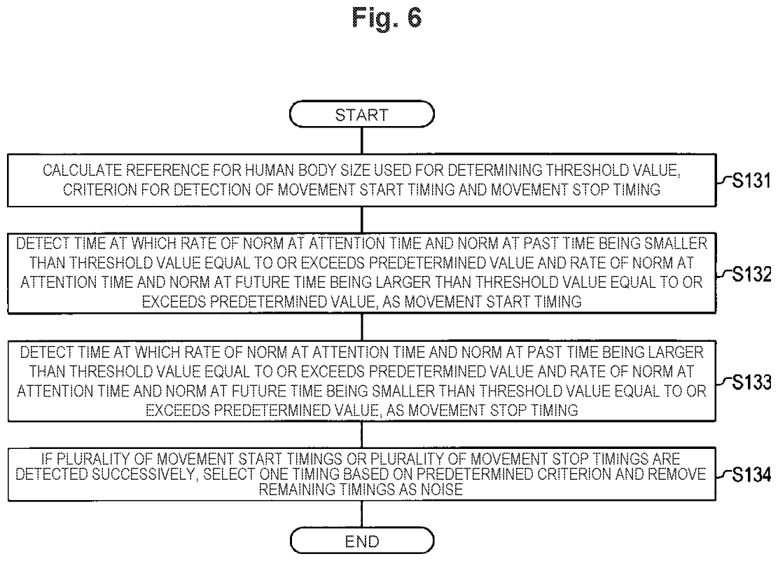

As illustrated in FIG. 6, the reference calculation unit 131 receives an input of video images taken from multiple viewpoints (in the present embodiment, two viewpoints) (video images taken of at least one person from different viewpoints), and calculates a reference for a human body size used for determining a threshold value that is a criterion for detection of a movement start timing and a movement stop timing (S131).

In order to determine a threshold value Thₘₒᵥₑ used in steps S132 and S133 below, the reference calculation unit 131 determines a reference for a size of a person (human body size) in a video image according to Expression (2) below. Note that a method of determining the threshold value Thₘₒᵥₑ is not limited to the below method. Since it is only required to specify a size of an object that is a reference in a video image, any arbitrary method may be employed for the calculation as long as such method meets the requirement.

Where the cameras are installed on a wide baseline, lengths of the arms and legs of the person from the respective viewpoints are different. Therefore, lengths of four parts of the body are calculated and a part having a largest length is determined as the size of the person in the image. First, in each of frames of t=1, . . . , Nⱼ, it is assumed that: η^{t}_{i, 1} is a length from the neck to the left wrist; η^{t}_{i, 2} is a length from the neck to the right. wrist; ^{t}_{i, 3} is a length from the neck to the left ankle; and ^{t}_{i, 4} is a length from the neck to the right ankle, and a center value of each of the length is calculated. Subsequently, the largest value of the four lengths is determined as a reference for the size of the person in an image from a viewpoint i.

$$\begin{matrix}[ Math . 2 ] & \\ {Size}_{i} = Max \{ Me \{ {η}_{i , 1}^{t} \} , Me \{ {η}_{i , 2}^{t} \} , Me \{ {η}_{i , 3}^{t} \} , Me \{ {η}_{i , 4}^{t} \} t = 1 , … , {N}_{j} \} & ( 2 )\end{matrix}$$

Next, the movement start timing detection unit 132 receives a chronological sequence of the norms of each joint in each video image and detects a time at which a rate of a norm at an attention time and a norm at a past time relative to the attention time being smaller than the threshold value Thₘₒᵥₑ is equal to or exceeds a predetermined value and a rate of the norm at the attention time and a norm at a future time relative to the attention time being larger than the threshold value is equal to or exceeds the predetermined value, as a movement start timing (S132).

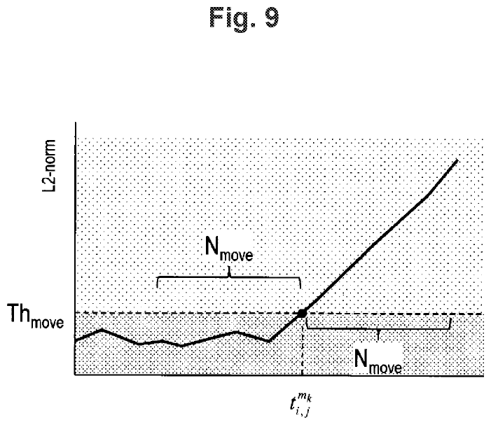

More specifically, for each joint, the movement start timing detection unit 132 detects a time t meeting conditions 1 and 2 below, as a movement start timing (see FIG. 9). Hereinafter, a movement start timing for a joint j from a viewpoint i is represented by

$${t}_{i , j}^{{m}_{k}} . \qquad [ Math . 3 ]$$

Condition 1: In a norm chronological sequence {n^{t}_{i, j}} of a joint j, a rate of the norm being smaller than the threshold value Thₘₒᵥₑ is equal to or exceeds γ during a period of t−Nₘₒᵥₑ frames from a frame t.
Condition 2: in the norm chronological sequence {n^{t}_{i, j}} of the joint j, a rate of the norm being larger than the threshold value Thₘₒᵥₑ is equal to or exceeds γ during a period of t+Nₘₒᵥₑ frames from the frame t.

The rate γ can be set to, for example, 0.7. It is possible to detect movement start timings with various values taken as γ in simulations and use a value of γ that enables most correct detection of a motion rhythm. Nₘₒᵥₑ represents a count of frames on the time axis. For example, in the case of a video of 30 bps, Nₘₒᵥₑ is set to 21 frames and Thₘₒᵥₑ is set to 2/255×sizeᵢ pixels. Each of these parameters can be determined in an arbitrary method.

For example, it is possible to visually select a timing that can clearly be recognized as a movement start timing, in advance and determine a parameter in such a manner as to enable detection of the visually selected timing using the above method.

Next, the movement stop timing detection unit 133 receives an input of the chronological sequence of the norms of each Mint in each video image, and detects a time at which a norm at an attention time and a norm at a past time being larger than the threshold value Thₘₒᵥₑ is equal to or exceeds the predetermined value and a rate of the norm at the attention time and a norm at a future time being smaller than the threshold value Thₘₒᵥₑ is equal to or exceeds the predetermined value, as a movement stop timing (S133).

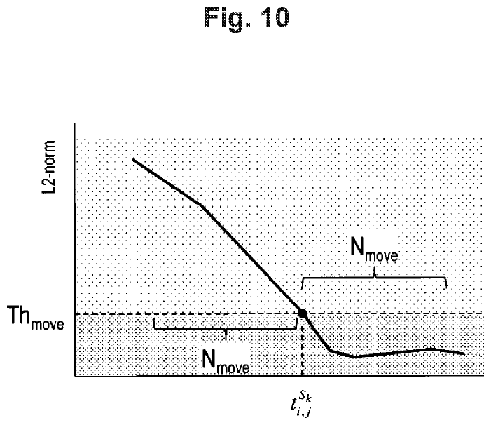

The movement stop timing detection unit 133 performs detection processing according to a method that is similar to that of detection of the movement start timings (see FIG. 10). Conditions for detection are indicated below.

Condition 1: in the norm chronological sequence {n^{t}_{i, j}} of the joint j, a rate of the norm being larger than the threshold value Thₘₒᵥₑ is equal to or exceeds γ during a period of t−Nₘₒᵥₑ frames from a frame t.
Condition 2: In the norm chronological sequence {n^{t}_{i, j}} of the joint j, a rate of the norm being smaller than the threshold value Thₘₒᵥₑ is equal to or exceeds γ during a period of t+Nₘₒᵥₑ frames from the frame t.

Next, if a plurality of movement start timings or a plurality of movement stop timings are detected successively, the noise removal unit 134 selects one timing based on a predetermined criterion and removes the remaining timings as noise (S134).

When steps S132 and S133 are performed, a plurality of movement start timings or a plurality of movement stop timings may successively be detected. In this case, the noise removal unit 134 selects one proper timing from these timings. Any method can be employed for the selection. For example, the noise removal unit 134 selects a leading timing of a group of successively detected timings as a proper timing. More specifically, the noise removal unit 134 sets a proper frame count N_{reduce} (for example, 70 percent of a frame rate of a video image), and if another movement start timing (or another movement stop timing) is detected within N_{reduce} frames from a certain movement start timing (or a certain movement stop timing), the noise removal unit 134 removes the timing detected successively as noise. The noise removal unit 134 outputs a motion rhythm (frame count and R_{i, j}) of each joint to the time shift detection unit 14.

Note that a motion rhythm is defined as

$${R}_{i , j} = \{ {t}_{i , j}^{{m}_{k}} , {t}_{i , j}^{{s}_{k}} \} , \qquad [ Math . 4 ]$$

by combining a movement start timing and a movement stop timing.

### Time shift Detection Unit 14

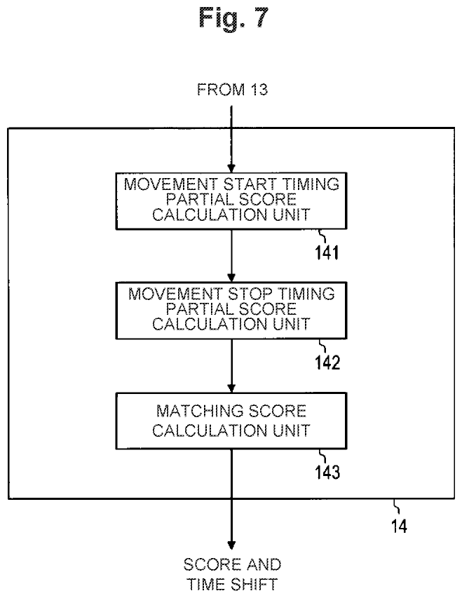

As illustrated in FIG. 7, the time shift detection unit 14 includes a movement start timing partial score calculation unit 141, a movement stop timing partial score calculation unit 142 and a matching score calculation unit 143.

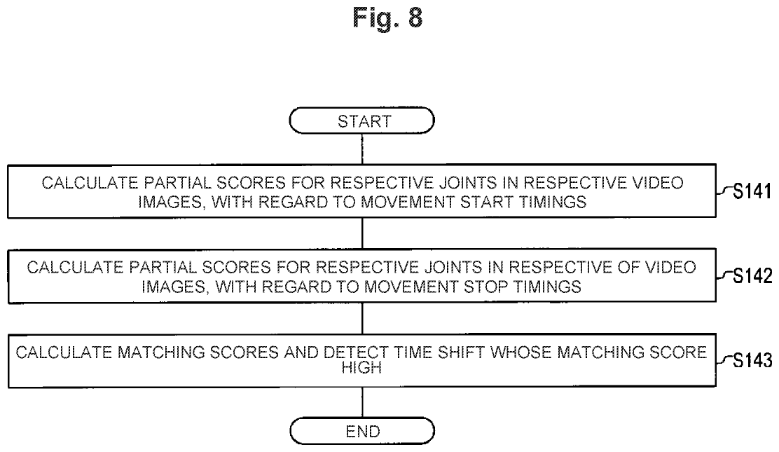

As illustrated in FIG. 8, the movement start timing partial score calculation unit 141 receives an input of the motion rhythms of the respective joints and calculates a partial score for each movement start timing (S141).

In detail, in a case where a synchronization error between a result of synchronization of an arbitrary joint in each of the video images that are subjects of the synchronization, using a value of a predetermined time shift, and a corresponding joint in a video image that is a reference for the synchronization is less than a predetermined threshold value, the movement start timing partial score calculation unit 141 provides a predetermined partial score (for example, 1) to the value of the predetermined time shift, and in a case other than the above case, the movement start timing partial score calculation unit 141 provides 0 to the value of the predetermined time shift as a partial score.

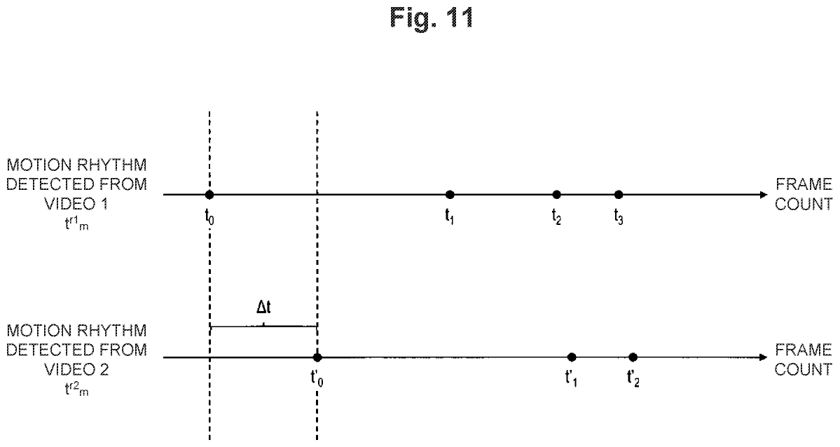

In more detail, the movement start timing partial score calculation unit 141 calculates a partial score for each time shift Δt (−N, . . . , N) based on Expression (5), using the movement start timings detected from the respective joints in the video images from multiple viewpoints (in the present embodiment, two viewpoints). N is a count of frames in an input video. FIG. 11 illustrates an idea of partial score calculation using timings t₀ and t′₀ detected first. If |t₀+Δt−t′₀|<thₙₑₐᵣ for each time shift Δt, that is, if a synchronization error between a result of synchronization of video 1 that is a subject of the synchronization and a video 2 that is a reference for the synchronization is less than a predetermined threshold value thₙₑₐᵣ, a partial score for the certain time shift Δt=1. Likewise, a partial score is calculated for each of all of the movement start timings,

$${t}_{i , j}^{{m}_{k}} . \qquad [ Math . 5 ]$$

Here, thₙₑₐᵣ may be any value. This value affects a final synchronization accuracy, and as the value is set to be larger, acquisition of a partial score becomes easier but the synchronization accuracy becomes lower. As the value is set to be smaller, the synchronization accuracy is enhanced more but acquisition of a partial score becomes more difficult, which may result in failure of synchronization. Here, it is assumed that the value is, for example, 1/30×(frame rate of video).

$$\begin{matrix}[ Math . 6 ] & \\ {reward}_{t} = \{ \begin{matrix}1 , & If ( \vert {t}_{0} + Δ t - {t}_{0}^{′} \vert < {th}_{near} ) \\ 0 , & otherwise\end{matrix} & ( 5 )\end{matrix}$$

Next, the movement stop timing partial score calculation unit 142 receives an input of the motion. rhythms of the respective joints and calculates a partial score for each movement stop timing (S142). Partial score calculation for the movement stop timings is similar to step S141. In other words, for each of all of the movement stop timings,

$${t}_{i , j}^{{s}_{k}} , \qquad [ Math . 7 ]$$

the movement stop timing partial score calculation unit 142 calculates a partial score.

Next, the matching score calculation unit 143 calculates matching scores and detects a time shift whose matching score is high (S143). Here, the matching scores are calculated by summation of partial scores for each of the time shifts.

In detail, for each time shift, the matching score calculation unit 143 obtains a sum of the partial scores at the respective times, the partial scores being obtained in steps S141 and S142 for respective frames in Δt on the time axis. As a value of the sum of the partial scores is larger, a degree of reliability of the time shift is higher. The matching score calculation unit 143 outputs, for example, a time shift δᵢ^{out} whose sum of the partial scores (=matching score) is largest. The final output is not limited to this example, but, for example, the matching score calculation unit 143 may obtain an average of time shifts having top three matching scores and output the average.

The operation of the matching score calculation unit 143 will more specifically be described. Motion rhythms R_{1, j} and R_{2, j} are motion rhythms detected from a video image C₁ and a video image C₂, respectively. It is assumed that when the two video images are synchronized, a same time shift δᵢ is used for the motion rhythms,

$$\begin{matrix}{R}_{1 , j} = {\{ {t}_{i , j}^{{m}_{k}} , {t}_{i , j}^{{s}_{k}} \}}_{1 , j} \\ {R}_{2 , j} = {\{ {t}_{i , j}^{{m}_{k}} , {t}_{i , j}^{{s}_{k}} \}}_{2 , j} .\end{matrix} \qquad [ Math . 8 ]$$

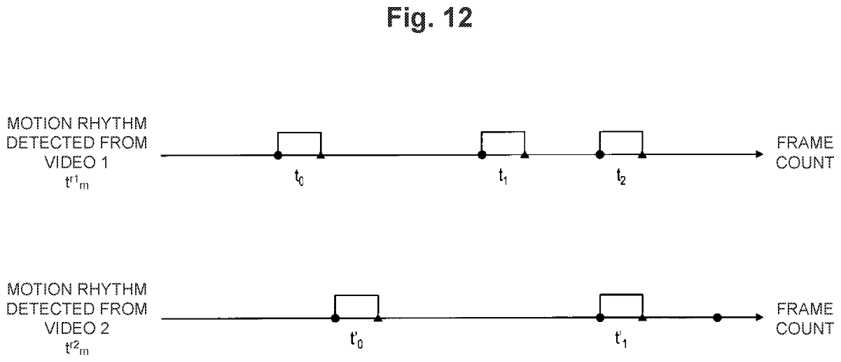

Other than the above-described method in which matching between movement start timings and matching of movement stop timings are performed separately, another method is conceivable. For example, as illustrate in FIG. 12, there is a method in which sets of a movement start timing and a movement stop timing are formed and matching is performed in terms of the sets. However, if there is an erroneously detected timing or a detection omission occurs in detection of motion rhythms, steps S141 to S143 may provide matching with higher accuracy. The matching method may be selected according to the accuracy of motion rhythm detection.

### Effects of Invention

The video image synchronization device 1 of the present embodiment enables synchronization of even video images on a wide baseline by means of introduction of motion rhythms, and enables stable synchronization even if an initial time shift is large or even if a correspondence point has a detection error.

### Supplement

A device of the present invention, for example, as a single hardware entity, includes an input unit to which, e.g., a keyboard is connectable, an output unit to which, e.g., a liquid-crystal display is connectable, a communication unit to which a communication device (for example, a communication cable) that enables communication with the outside of the hardware entity, a CPU (central processing unit, which may include, e.g., a cache memory and a register), a RAM and a ROM, each of which is a memory, and an external storage device, which is a hard disk, and a bus connecting the input unit, the output unit, the communication unit, the CPU, the RAM, the ROM and the external storage device in such a manner that data can be transmitted/received among these units, the memories and the device. Also, as necessary, e.g., a device (drive) capable of reading/writing to/from a recording medium such as a CD-ROM may be provided in the hardware entity. Examples of a physical entity including these hardware resources include, e.g., a general-purpose computer.

In the external storage device of the hardware entity, e.g., programs necessary for implementing the above-described functions and data necessary for processing of the programs are stored (riot only in the external storage device, but also, for example, the programs may be stored in the ROM, which is a read-only storage device). Also, data, etc., obtained as a result of processing of the programs are appropriately stored in, e.g., the RAM or the external storage device.

In the hardware entity, the respective programs and data necessary for processing of the programs that are stored in the external storage device (or, e.g., the ROM) are read into a memory as necessary and appropriately interpreted and executed or processed by the CPU. As a result, the CPU implements predetermined functions (respective components each referred to as, e.g., “ . . . unit” or “ . . . means” above).

The present invention is not limited to the above-describe embodiment and appropriate changes are possible without departing from the spirit of the present invention. Also, the processing steps described in the above embodiment may be performed not only chronologically according to the order in which the processing steps are described, but also in parallel or individually according to a processing capacity of the device that performs the processing steps or as necessary.

As already described, where the processing functions in the hardware entity (device of the present invention) described in the present embodiment are implemented by a computer, the content of processing by each of the functions that the hardware entity should have is described by a program. Then, upon execution of the programs by the computer, the processing functions in the hardware entity are implemented in the computer.

The programs that describe the respective processing contents can be recorded on a computer-readable recording medium. The computer-readable recording medium may be any one, for example, a magnetic recording device, an optical disc, a magneto-optical recording medium or a semiconductor memory. More specifically, for example, as a magnetic recording device, e.g., a hard disk device, a flexible disk or a magnetic tape can be used, as an optical disc, e.g., a DVD (digital versatile disc) , a DVD-RAM (random access memory), a CD-ROM (compact disc read-only memory), a CD-R (recordable)/RW (rewritable) can be used, as a magneto-optical recording medium, e.g., an MO (magneto-optical disc) can be used, and as a semiconductor memory, an EEP-ROM (electronically erasable programmable read-only memory) can be used.

Also, distribution of the programs is conducted by, e.g., sale, transfer, or lending of a removable recording medium such as a DVD or a CD-ROM with the programs recorded thereon. Furthermore, the programs may be distributed by storing the programs in a storage device of a server computer and transferring the programs from the server computer to another computer via a network.

A computer that executes such programs, for example, first, stores the programs recorded on the removable recording medium or the program transferred from the server computer in its own storage medium once. Then, at the time of performing processing, the computer reads the programs stored in its own storage device and performs processing according to the read programs. Also, as another mode of execution of the programs, the computer may read the programs directly from the removable recording medium and perform processing according to the programs, or each time the program is transferred from the server computer to the computer, the computer may perform processing according to the received programs. Also, the above-described processing may be performed by what is called ASP (application service provider) service in which the processing functions are implemented by an instruction for execution of the programs and acquisition of a result of the execution without transfer of the programs from the server computer to the computer. Note the programs in the present mode include information provided for processing by an electronic calculator, the information being equivalent to a program (e.g., data that is not a direct instruction to the computer but has a nature of specifying processing in the computer).

Also, although in this mode, the hardware entity is configured by performing predetermined programs in a computer, at least a part of the processing contents may be implemented using hardware.

1. A video image synchronization device comprising:
a norm determiner configured to, from chronological data of a coordinate of each of joints of a human body in each of video images taken from a plurality of viewpoints, determine a norm that is a movement amount per unit time of the joint in the video image;
a motion rhythm detector configured to, based on the norms, detect a motion rhythm including a movement start timing and a movement stop timing, for each of the joints in each of the video images; and
a time shift detector configured to, based on the motion rhythms of the respective joints in the respective video images, determine a matching score indicating a degree of stability of a time shift between the video images and detect the time shift whose matching score is high.

2. The video image synchronization device according to claim 1, wherein the motion rhythm detector includes a reference determiner configured to determine a reference for a human body size used for determining a threshold value that is a criterion for detection of the movement start timing and the movement stop timing.

3. The video image synchronization device according to claim 1, wherein the motion rhythm detector includes a noise remover configured to, in a case where a plurality of the movement start timings or a plurality of the movement stop timings are successively detected, select one timing based on a predetermined criterion and remove remaining timings as noise.

4. The video image synchronization device according to claim 1, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

5. A video image synchronization method that is executed by a video image synchronization device, the video image synchronization method comprising:
determining, by a norm determiner, from chronological data of a coordinate of each of joints of a human body in each of video images taken from a plurality of viewpoints, a norm that is a movement amount per unit time of the joint in the video image;
detecting, by a motion rhythm detector, based on the norms, a motion rhythm including a movement start timing and a movement stop timing, for each of the joints in each of the video images;
determining, by a time shift detector, based on the motion rhythms of the respective joints in the respective video images, calculating a matching score indicating a degree of stability of a time shift between the video images; and
detecting, by the time shift detector, the time shift whose matching score is high.

6. A computer-readable non-transitory recording medium storing computer-executable program instructions that when executed by a processor cause a computer system to:
determine, by a norm determiner, from chronological data of a coordinate of each of joints of a human body in each of video images taken from a plurality of viewpoints, a norm that is a movement amount per unit time of the joint in the video image;
detect, by a motion rhythm detector, based on the norms, a motion rhythm including a movement start timing and a movement stop timing, for each of the joints in each of the video images;
determine, by a time shift detector, based on the motion rhythms of the respective joints in the respective video images, a matching score indicating a degree of stability of a time shift between the video images; and
detect, by the time shift detector, the time shift whose matching score is high.

7. The video image synchronization device according to claim 2, wherein the motion rhythm detector includes a noise remover configured to, in a case where a plurality of the movement start timings or a plurality of the movement stop timings are successively detected, select one timing based on a predetermined criterion and remove remaining timings as noise.

8. The video image synchronization device according to claim 2, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

9. The video image synchronization device according to claim 3, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

10. The video image synchronization method according to claim 5, wherein the motion rhythm detector includes a reference determiner configured to determine a reference for a human body size used for determining a threshold value that is a criterion for detection of the movement start timing and the movement stop timing.

11. The video image synchronization method according to claim 5, wherein the motion rhythm detector includes a noise remover configured to, in a case where a plurality of the movement start timings or a plurality of the movement stop timings are successively detected, select one timing based on a predetermined criterion and remove remaining timings as noise.

12. The video image synchronization method according to claim 5, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

13. The computer-readable non-transitory recording medium of claim 6, wherein the motion rhythm detector includes a reference determiner configured to determine a reference for a human body size used for determining a threshold value that is a criterion for detection of the movement start timing and the movement stop timing.

14. The computer-readable non-transitory recording medium of claim 6, wherein the motion rhythm detector includes a noise remover configured to, in a case where a plurality of the movement start timings or a plurality of the movement stop timings are successively detected, select one timing based on a predetermined criterion and remove remaining timings as noise.

15. The computer-readable non-transitory recording medium of claim 6, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

16. The video image synchronization method according to claim 10, wherein the motion rhythm detector includes a noise remover configured to, in a case where a plurality of the movement start timings or a plurality of the movement stop timings are successively detected, select one timing based on a predetermined criterion and remove remaining timings as noise.

17. The video image synchronization method according to claim 10, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

18. The video image synchronization method according to claim 11, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.

19. The computer-readable non-transitory recording medium of claim 13, wherein the motion rhythm detector includes a noise remover configured to, in a case where a plurality of the movement start timings or a plurality of the movement stop timings are successively detected, select one timing based on a predetermined criterion and remove remaining timings as noise.

20. The computer-readable non-transitory recording medium of claim 13, wherein in a case where a synchronization difference between a result of synchronization of an arbitrary joint in each of the video images that are subjects of the synchronization using a value of a predetermined time shift and a corresponding joint in a video image that is a reference for synchronization is less than a predetermined threshold value, a predetermined partial score is provided to the value of the predetermined time shift, and in a case other than the case, 0 is provided to the value of the predetermined time shift as the partial score, and the matching score is calculated by summation of the partial scores.
